(19) United States
(12) Patent Application Publication
(10) Pub. No.: US 2013/0312572 A1
(43) Pub. Date: Nov. 28, 2013

(54) Can opening device

(71) Applicant: Richard Bisechich, Tucson, AZ (US)

(72) Inventor: Richard Bisechich, Tucson, AZ (US)

(21) Appl. No.: 13/481,759

(22) Filed: May 25, 2012

(51) Int. Cl. B67B 7/00

(52) U.S. Cl. 81/3.07

(57) ABSTRACT

The present invention is a can opening device that includes a can opener that includes an angle bit, a pair of scissor-type handles that are squeezed to press and removably secure the can after the can is opened by the can opener, a main handle that extends horizontally at a slight upward angle from the can opener and a pivot point that movably connects the scissor-type handles and a knob to relatively better grasp the device. The device also includes a threaded stem that is threaded through the pair of scissor-type handles, a triangular support disposed on the threaded stem, a lid press with a magnet strip and a generally circular-shaped support dish disposed on the bottom horizontal handle of the pair of scissor-type handles before the first end of the pair of horizontal handles.

### TECHNICAL FIELD & BACKGROUND

Conventional hand-held can openers require the user to clamp a pair of handles and repeatedly twist a knob which in turn perforates a can, eventually completing a full circle and offering an open can. However, this method can often be time consuming or cumbersome, specifically to those with small hands or those who may not be able to squeeze as hard as is necessary to use the can opener.

The present invention generally relates to an opening device. More specifically, the invention is a can opening device.

It is an object of the invention to provide a can opening device that is relatively cleaner and easier to utilize than a traditional can opener.

It is an object of the invention to provide a can opening device that is relatively more durable than a traditional can opener.

It is an object of the invention to provide a can opening device that drains fluid out of a can being opened and lifts a lid off of the opened can at the same time.

What is really needed is a can opening device that is relatively cleaner and easier to utilize than a traditional can opener that is relatively more durable than a traditional can opener that drains fluid out of a can being opened and lifts a lid off of the opened can at the same time.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a side environmental view of a can opening device, according to an embodiment of the present invention.

FIG. 1B illustrates a cross-sectional view along line 1A-1A from FIG. 1A of a support dish of a can opening device, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

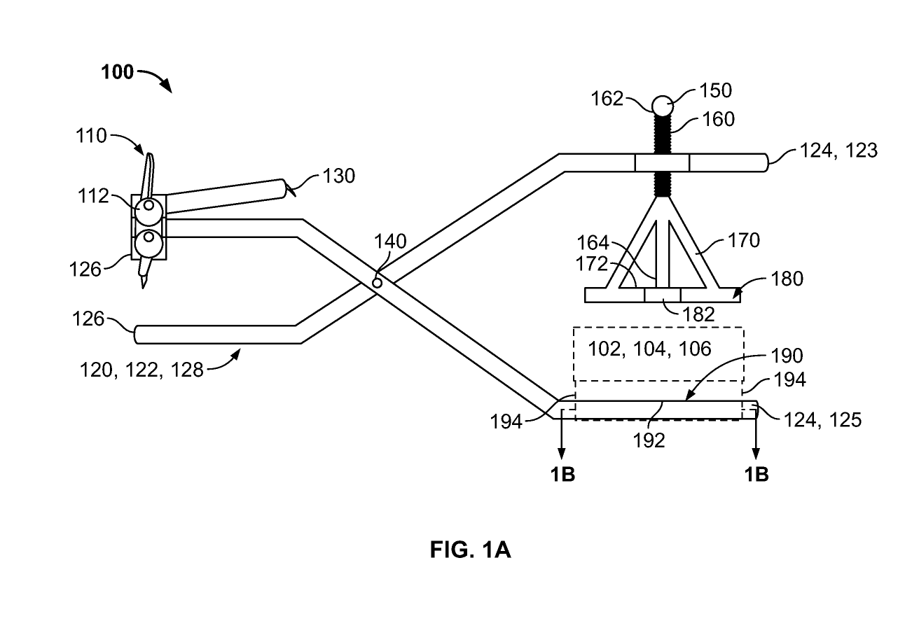

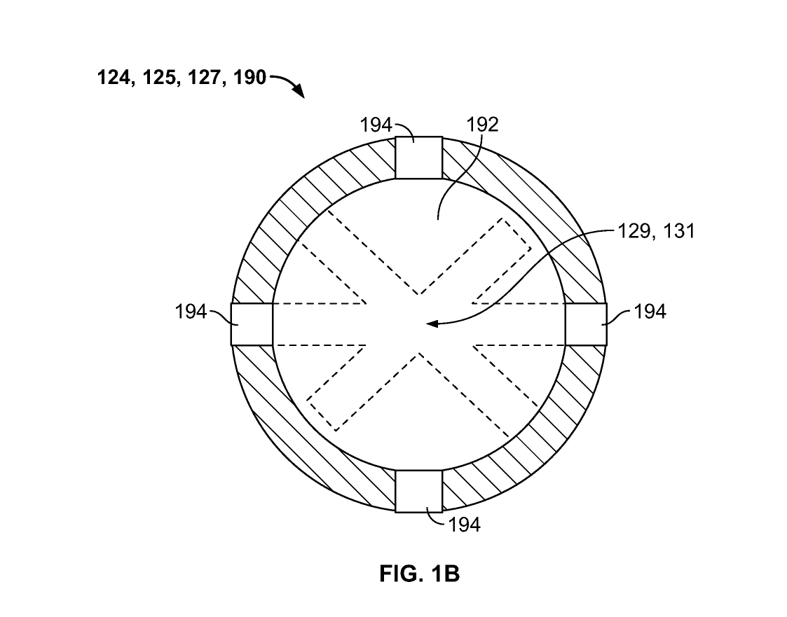

FIG. 1A illustrates a side environmental view of a can opening device 100, according to an embodiment of the present invention. The can opening device 100 can be utilized to open any suitable can 102 but is typically used to open a can of tuna fish 104 or a can of chicken 104.

The can opening device 100 includes a can opener 110, a handle 120, a main handle 130, a pivot point 140, a knob 150, a threaded stem 160, a triangular support 170, a lid press 180 and a support dish 190. The can opener 110 has an angle bit 112 that is utilized to open a can 102 that is typically a metal can or a tin can or other suitable can material. The handle 120 is a pair of horizontal handles 122 with a pair of first ends 124 and a pair of second ends 126 where the can opener 110 is disposed and utilized on one of the pair of second ends 126 of the handle 120. The pair of horizontal handles 122 are scissor-type handles 128 that are squeezed to press and removably secure a can 102 to be drained after the can 102 is opened by the can opener 110 but can be any other suitable type of handle. The main handle 130 extends horizontally at a relatively slight upward angle from the can opener 110 and folds over the pair of horizontal handles 122 to save space and provide convenient storage of the can opening device 100. The pivot point 140 movably connects the pair of horizontal handles 122 allowing for a scissoring movement to press and removably secure a can 102 to be drained after the can 102 is opened by the can opener 110. The knob 150 is utilized to assist a user to relatively better grasp the can opening device 100. The threaded stem 160 has a first end 162 and a second end 164 that is threaded through before the first end 124 of the top horizontal handle 123 of the pair of scissor-type handles 128. The triangular support 170 has a bottom 172 that is disposed on the second end 164 of the threaded stem 160. The lid press 180 is disposed on the bottom 172 of the triangular support 170 and includes a magnet strip 182 that is centered on the lid press 180 but can be any suitable quantity and type of magnetic material disposed on a perimeter of the lid press 180. The support dish 190 has a top surface 192 and is disposed on the bottom horizontal handle 125 of the pair of scissor-type handles 128 before the first end 124 of the bottom horizontal handle 125 of the pair of scissor-type handles 128 and includes a plurality of raised notches 194 to secure the can 102 and allow the lid press 180 to squeeze and drain any fluid (not shown) present within the can 102. The top surface 192 of the support dish 190 is made of non-slip material or any other suitable material. Typically the fluid in the can 102 is drained by the user simply tilting the can 102 downward and pouring off the fluid out of the can 102.

FIG. 1B illustrates a cross-sectional view along line 1A-1A from FIG. 1A of a support dish 190 of a can opening device 100, according to one embodiment of the present invention.

FIG. 1B illustrates the first end 124 on the bottom horizontal handle 125 with the support dish 190 disposed on the first end 124 of the bottom horizontal handle 125 of the pair of scissor-type handles 128. The first end 124 on the bottom horizontal handle 125 with the support dish 190 disposed on the first end 124 of the bottom horizontal handle 125 illustrated and described in FIG. 1B is similar to the first end 124 on the bottom horizontal handle 125 with the support dish 190 disposed on the first end 124 of the bottom horizontal handle 125 illustrated and described in FIG. 1A. The support dish 190 is generally circular-shaped 127 and has a cross-diagonal pattern 129 with three diagonal lines 131 that is made of non-slip material but can be any suitable pattern and material. The raised notches 194 secure the can 102 and allow the lid press 180 to squeeze and drain any fluid (not shown) present within the can 102 against the support dish 190 which can be performed by tilting the can 102 downward and pouring off the fluid out of the can 102.

The can opener device is a scissors-like device capable of draining fluid from a container which is typically a can and removing a lid from the container by relatively gently squeezing a pair of handles from the can opener device. The can opener device is relatively easy to operate, where a user simply places the can opener device on one end of the pair of handles and places the can in a round dish-like support on the can opener device. The user then relatively gently squeezes the pair of handles and turns the can opener device sideways in order to drain any fluid present within the opened can. Once the user drains the fluid from the can, the can opener device is straightened and the user releases the pair of handles back to an open position, thereby extracting the lid out of the opened can by way of an afforded magnet mounted in a center portion of the bottom of a lid press from the can opener device. Among those who will find the can opener device practical and convenient are can opener manufacturers and everyday consumers. The can opener device features a lid press engineered to hold the can in place while the fluids are being drained, that is adjustable in order to effectively secure the container. The can opener device is designed with a plurality of non-slip distal end can supporters in order to eliminate any mess while draining any fluid present.

Use of the can opener device includes the steps of opening a can, placing the opened can in a support dish and adjusting a lid press into position above the can, squeezing a pair of scissor handles provided on the device and securing and tilting the can downward and pouring off any fluid within the can, removing a lid on the can with a magnet disposed on the lid press and removing the can from the device.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A can opening device, comprising:
a can opener that includes an angle bit, said angle bit is utilized to open a can;
a pair of horizontal handles with a pair of first ends with a top horizontal handle and a bottom horizontal handle and a pair of second ends, said pair of horizontal handles are squeezed to press and removably secure said can after said can is opened by said can opener;
a main handle that extends horizontally at a slight upward angle from said can opener and folds over said pair of horizontal handles to save space and provide convenient storage of said can opening device;
a pivot point that movably connects said scissor-type handles allowing a scissoring movement to press and removably secure said can;
a knob utilized to assist a user to relatively better grasp said can opening device;
a threaded stem with a first end and a second end that is threaded through before said first end of said top horizontal handle of said pair of scissor-type handles;
a triangular support with a bottom, said triangular support is disposed on said second end of said threaded stem;
a lid press disposed on said bottom of said triangular support; and
a generally circular-shaped support dish with a top surface, said generally circular-shaped support dish is disposed on said bottom horizontal handle of said pair of scissor-type handles before said first end of said pair of horizontal handles.

2. The can opening device according to claim 1, wherein said can opener is disposed and utilized on one of said second ends of said handle.

3. The can opening device according to claim 1, wherein said pair of horizontal handles is a scissor-type handle.

4. The can opening device according to claim 1, wherein said lid press includes a magnet strip on said bottom of said triangular support.

5. The can opening device according to claim 1, wherein said support dish includes a plurality of raised notches to secure said can and allow said lid press to squeeze and drain any fluid present within said can.

6. The can opening device according to claim 5, wherein said fluid in said can is drained by said user tilting said can downward and pouring off said fluid out of said can.

7. The can opening device according to claim 1, wherein said can is a can of tuna fish.

8. The can opening device according to claim 1, wherein said can is a can of chicken.

9. The can opening device according to claim 1, wherein said can is made of metal.

10. The can opening device according to claim 9, wherein said can is made of tin.

11. A can opening device, comprising:
a can opener that includes an angle bit, said angle bit is utilized to open a can;
a pair of scissor-type handles with a pair of first ends with a top horizontal handle and a bottom horizontal handle and a pair of second ends, said pair of horizontal handles are squeezed to press and removably secure said can after said can is opened by said can opener;
a main handle that extends horizontally at a slight upward angle from said can opener and folds over said pair of horizontal handles to save space and provide convenient storage of said can opening device;
a pivot point that movably connects said scissor-type handles allowing a scissoring movement to press and removably secure said can;
a knob utilized to assist a user to relatively better grasp said can opening device;
a threaded stem with a first end and a second end that is threaded through before said first end of said top horizontal handle of said pair of scissor-type handles;
a triangular support with a bottom, said triangular support is disposed on said second end of said threaded stem;
a lid press with a magnet strip, said magnetic strip disposed on said bottom of said triangular support; and
a generally circular-shaped support dish with a top surface, said generally circular-shaped support dish is disposed on said bottom horizontal handle of said pair of scissor-type handles before said first end of said pair of horizontal handles.

12. The can opening device according to claim 11, wherein said can opener is disposed and utilized on one of said second ends of said handle.

13. The can opening device according to claim 11, wherein said support dish includes a plurality of raised notches to secure said can and allow said lid press to squeeze and drain any fluid present within said can.

14. The can opening device according to claim 13, wherein said fluid in said can is drained by said user tilting said can downward and pouring off said fluid out of said can.

15. The can opening device according to claim 11, wherein said can is a can of tuna fish.

16. The can opening device according to claim 11, wherein said can is a can of chicken.

17. The can opening device according to claim 11, wherein said can is made of metal.

18. The can opening device according to claim 18, wherein said can is made of tin.

19. The can opening device according to claim 11, wherein said magnet strip is centered on said lid press.

20. The can opening device according to claim 11, wherein said top surface of said support dish is made of non-slip material.
